(19) United States
(12) Patent Application Publication
(10) Pub. No.: US 2022/0363259 A1
(43) Pub. Date: Nov. 17, 2022

(54) METHOD FOR GENERATING LANE CHANGING DECISION-MAKING MODEL, METHOD FOR LANE CHANGING DECISION-MAKING OF UNMANNED VEHICLE AND ELECTRONIC DEVICE

(71) Applicant: Momenta (Suzhou) Technology Co., Ltd., Suzhou City, Jiangsu Province (CN)

(72) Inventors: Tianyu SHI, Suzhou City, Jiangsu Province (CN); Xu RAN, Suzhou City, Jiangsu Province (CN)

(73) Assignee: Momenta (Suzhou) Technology Co., Ltd., Suzhou City, Jiangsu Province (CN)

(21) Appl. No.: 17/773,378

(22) PCT Filed: Oct. 16, 2020
(86) PCT No.: PCT/CN2020/121339

§ 371 Date: Apr. 29, 2022

(30) Foreign Application Priority Data
Nov. 27, 2019 (CN) 201911181338.0

(51) Int. Cl. B60W 30/18; B60W 50/00; G06N 3/08

(52) U.S. Cl. CPC B60W 30/18163; B60W 50/0097; G06N 3/08; B60W 2520/10; B60W 2520/105; B60W 2554/4042; B60W 2554/4041; B60W 2552/10

(57) ABSTRACT

Provided are a method for generating a lane changing decision-making model and a method and an apparatus for lane changing decision-making of an unmanned vehicle. The method for generating a lane changing decision-making model includes: obtaining a training sample set of vehicular lane changing, wherein the training sample set includes a plurality of training sample groups, each of the training sample groups includes a training sample under each time step length in a process that the vehicle completes lane changing based on a planned lane changing trajectory, the training sample includes a group of state variables and corresponding control variables; obtaining the lane changing decision-making model by training a decision-making model based on deep reinforcement learning network by use of the training sample set, wherein the lane changing decision-making model enables the state variable of the target vehicle and the corresponding control variable to be correlated.

### TECHNICAL FIELD

The present disclosure relates to the field of self driving technologies, and in particular to a method for generating a lane changing decision-making model and a method and an apparatus for lane changing decision-making of an unmanned vehicle.

### BACKGROUND

In the self driving field, the architecture of the autonomous system of the self driving vehicle usually includes a sensing system and a decision-making control system. A conventional decision-making control system adopts an optimization-based algorithm, but most of the classical optimization-based methods cannot solve complex decision-making tasks due to complex computation amount. Actually, the vehicle travel conditions are complex and in an unstructured environment, a self-driving vehicle uses complex sensors, for example, cameras and laser rangers. Because the sensing data obtained by the above sensors usually depends on complex and unknown environment, it is difficult to output an optimal control variable based on algorithm by directly inputting the above sensing data obtained by the above sensors into the frame of the algorithm. In a conventional method, an environment is usually mapped by use of slam algorithm and then a trajectory is obtained from a result map. However, in this model-based algorithm, there will be more unstable factors due to uncertainty of height (for example, bumpy road) when a vehicle travels.

### SUMMARY

The present disclosure provides a method for generating a lane changing decision-making model, and a method and an apparatus for lane changing decision-making of an unmanned vehicle so as to solve at least one technical problem in the prior arts.

According to a first aspect of embodiments of the present disclosure, there is provided a method of generating a lane changing decision-making model, including:

obtaining a training sample set of vehicular lane changing, wherein the training sample set includes a plurality of training sample groups, each of the training sample groups includes a training sample under each time step length in a process that the vehicle completes lane changing based on a planned lane changing trajectory, the training sample includes a group of state variables and corresponding control variables, the state variables include a pose, a speed and an acceleration of a target vehicle, a pose, a speed and an acceleration of a front vehicle in the present lane of the target vehicle and a pose, a speed and an acceleration of a following vehicle in a target lane; and the control variables comprise a speed and an angular speed of the target vehicle;

obtaining the lane changing decision-making model by training a decision-making model based on deep reinforcement learning network by use of the training sample set, wherein the lane changing decision-making model enables the state variable of the target vehicle and the corresponding control variable to be correlated.

Optionally, the training sample set may be obtained in at least one of the following manners:

in a first manner

a vehicle is enabled to complete lane changing according to a rule-based optimization algorithm in a simulator to obtain the state variables of the target vehicle, the front vehicle in the present lane of the target vehicle and the following vehicle in the target lane under each time step length during a process of multiple lane changings and the corresponding control variables;

in a second manner

vehicle data in a vehicular lane changing is sampled from a database storing vehicular lane changing information, wherein the vehicle data includes the state variables of the target vehicle, the front vehicle in the present lane of the target vehicle and the following vehicle in the target lane under each time step length and the corresponding control variables.

Optionally, the decision-making model based on deep reinforcement learning network includes a learning-based prediction network and a pre-trained rule-based target network, and the step of obtaining the lane changing decision-making model by training the decision-making model based on deep reinforcement learning network by use of the training sample set includes:

for a training sample set pre-added to an experience pool, with any state variable in each group of training samples as an input of the prediction network, obtaining a prediction control variable of the prediction network for a next time step length of the state variable; with a state variable of the next time step length of the state variable in the training sample and a corresponding control variable as an input of the target network, obtaining a value evaluation Q value output by the target network;

with the prediction control variable as an input of a pre-constructed environmental simulator, obtaining an environmental reward and a state variable of the next time step length output by the environmental simulator;

storing the state variable, the corresponding prediction control variable, the environmental reward and the state variable of the next time step length as a group of experience data into the experience pool;

after the number of the groups of the experience data reaches a first preset number, according to multiple groups of experience data and the Q value output by the target network and corresponding to each group of experience data, calculating and optimizing a loss function to obtain a gradient of change of parameters of the prediction network and updating the parameters of the prediction network until the loss function converges.

Optionally, after the step of, after the number of the groups of the experience data reaches the first preset number, according to the experience data, calculating and iteratively optimizing the loss function to obtain the updated parameters of the prediction network, is performed, the method further includes:

after the number of the updates of the parameters of the prediction network reaches a second preset number, obtaining a prediction control variable with an environmental reward higher than a preset value and a corresponding state variable in the experience pool, or obtaining prediction control variables with environmental rewards ranked in top third preset number and corresponding state variables in the experience pool, and adding the prediction control variable and the corresponding state variable to a target network training sample set of the target network to train and update the parameters of the target network.

Optionally, the loss function is a mean square error of a first preset number of value evaluation Q values of the prediction network and the value evaluation Q value of the target network, wherein the value evaluation Q value of the prediction network is about an input state variable, a corresponding prediction control variable and a policy parameter of the prediction network; and the value evaluation Q value of the target network is about a state variable of an input training sample, a corresponding control variable and a policy parameter of the target network.

According to a second aspect of embodiments of the present disclosure, there is provided a method of lane changing decision-making of an unmanned vehicle, including:

at a determined lane changing moment, obtaining sensor data in body sensors of a target vehicle, wherein the sensor data includes poses, speeds and accelerations of the target vehicle, a front vehicle in the present lane of the target vehicle and a following vehicle in a target lane;

invoking a lane changing decision-making model to obtain a control variable of the target vehicle at each moment during a lane changing process, wherein the lane changing decision-making model enables a state variable of the target vehicle and a corresponding control variable to be correlated;

sending the control variable of each moment during a lane changing process to an actuation mechanism to enable the target vehicle to complete lane changing.

According to a third aspect of embodiments of the present disclosure, there is provided an apparatus for generating a lane changing decision-making model, including:

a sample obtaining module, configured to obtain a training sample set of vehicular lane changing, wherein the training sample set includes a plurality of training sample groups, each of the training sample groups includes a training sample under each time step length in a process that the vehicle completes lane changing based on a planned lane changing trajectory, the training sample includes a group of state variables and corresponding control variables, the state variables include a pose, a speed and an acceleration of a target vehicle, a pose, a speed and an acceleration of a front vehicle in the present lane of the target vehicle and a pose, a speed and an acceleration of a following vehicle in a target lane; and the control variables include a speed and an angular speed of the target vehicle;

a model training module, configured to obtain the lane changing decision-making model by training a decision-making model based on deep reinforcement learning network by use of the training sample set, wherein the lane changing decision-making model enables the state variable of the target vehicle and the corresponding control variable to be correlated.

Optionally, the decision-making model based on deep reinforcement learning network includes a learning-based prediction network and a pre-trained rule-based target network, and the model training module includes:

a sample inputting unit, configured to, for a training sample set pre-added to an experience pool, with any state variable in each group of training samples as an input of the prediction network, obtain a prediction control variable of the prediction network for a next time step length of the state variable; with a state variable of the next time step length of the state variable in the training sample and a corresponding control variable as an input of the target network, obtain a value evaluation Q value output by the target network;

a reward generating unit, configured to, with the prediction control variable as an input of a pre-constructed environmental simulator, obtain an environmental reward and the state variable of the next time step length output by the environmental simulator;

an experience storing unit, configured to store the state variable, the corresponding prediction control variable, the environmental reward and the state variable of the next time step length as a group of experience data into the experience pool;

a parameter updating unit, configured to, after the number of the groups of the experience data reaches a first preset number, according to multiple groups of experience data and the Q value output by the target network and corresponding to each group of experience data, calculate and optimize a loss function to obtain a gradient of change of parameters of the prediction network and update the parameters of the prediction network until the loss function converges.

Optionally, the parameter updating unit is further configured to:

after the number of the updates of the parameters of the prediction network reaches a second preset number, obtain a prediction control variable with an environmental reward higher than a preset value and a corresponding state variable in the experience pool, or obtain prediction control variables with environmental rewards ranked in top third preset number and corresponding state variables in the experience pool, and add the prediction control variable and the corresponding state variable to a target network training sample set of the target network to train and update the parameters of the target network.

According to a fourth aspect of embodiments of the present disclosure, there is provided an apparatus for lane changing decision-making of an unmanned vehicle, including:

a data obtaining module, configured to, at a determined lane changing moment, obtain sensor data in body sensors of a target vehicle, wherein the sensor data includes poses, speeds and accelerations of the target vehicle, a front vehicle in the present lane of the target vehicle and a following vehicle in a target lane;

a control variable generating module, configured to invoke a lane changing decision-making model to obtain a control variable of the target vehicle at each moment during a lane changing process, wherein the lane changing decision-making model enables a state variable of the target vehicle and a corresponding control variable to be correlated;

a control variable outputting module, configured to send the control variable of each moment during a lane changing process to an actuation mechanism to enable the target vehicle to complete lane changing.

The embodiments of the present disclosure have the following beneficial effects:

According to the method for generating a lane changing decision-making model and the method and apparatus for lane changing decision-making of an unmanned vehicle, a decision-making model based on deep reinforcement learning network is trained by use of obtained training sample set, where the decision-making model includes a learning-based prediction network and a pre-trained rule-based target network; each group of state variables in the training sample set are input into the prediction network and the state variables of a next time step length of the state variables in the training sample set and corresponding control variables are input into the target network; according to a value estimation of an execution result of corresponding prediction control variable output by the prediction network and a value estimation of the target network for input training sample, a loss function is calculated and solved to update the policy parameters of the prediction network, such that the policy of the prediction network is continuously approximate to the policy of the training sample data. According to a rule-based policy, a learning-based neural network is directed to perform spatial search from state variable to control variable, such that the planning-based optimization algorithm is put into the frame of reinforcement learning to improve the planning efficiency of the prediction network. Further, the addition of the rule-based policy solves the problem that the loss function may be subjected to non-convergence, thus increasing the stability of the model. The decision-making model can correlate the state variable of the target vehicle with the corresponding control variable. Compared with the conventional offline optimization algorithm, the inputs of the sensors can be directly received and good online planning efficiency can be produced, thus solving the problem of difficult decision-making resulting from complex sensors and environmental uncertainty in the prior arts; compared with pure deep neural network, better planning efficiency can be generated and adaptability to specific application scenarios can be increased.

The embodiments of the present disclosure have the following inventive points:

1. A decision-making model based on deep reinforcement learning network is trained by use of obtained training sample set, where the decision-making model includes a learning-based prediction network and a pre-trained rule-based target network; each group of state variables in the training sample set are input into the prediction network and the state variables of a next time step length of the state variables in the training sample set and corresponding control variables are input into the target network; according to a value estimation of an execution result of corresponding prediction control variable output by the prediction network and a value estimation of the target network for input training sample, a loss function is calculated and solved to update the policy parameters of the prediction network, such that the policy of the prediction network is continuously approximate to the policy of the training sample data. According to a rule-based policy, a learning-based neural network is directed to perform spatial search from state variable to control variable, such that the planning-based optimization algorithm is put into the frame of reinforcement learning to improve the planning efficiency of the prediction network. Further, the addition of the rule-based policy solves the problem that the loss function may be subjected to non-convergence, thus increasing the stability of the model. The decision-making model can correlate the state variable of the target vehicle with the corresponding control variable. Compared with the conventional offline optimization algorithm, the inputs of the sensors can be directly received and good online planning efficiency can be produced, thus solving the problem of difficult decision-making resulting from complex sensors and environmental uncertainty in the prior arts; compared with pure deep neural network, better planning efficiency can be generated and adaptability to specific application scenarios can be increased. The above is one of the inventive points of the present disclosure.

2. The value evaluation is calculated for the policy of the training sample according to the rule-based target network to direct the learning-based prediction network to perform spatial search from state variable to control variable and direct the updating of the policy of the prediction network based on optimization policy such that the deep reinforcement learning network can solve the complex lane changing decision-making problem, which is one of the inventive points of the present disclosure.

3. The lane changing decision-making model obtained by the method herein can directly learn sensor data input by the sensors and output the corresponding control variables, which solves the problem of difficult decision-making resulting from complex sensors and environmental uncertainty in the prior arts. Fusion of the optimized manner and the deep learning network achieves good planning efficiency, which is one of inventive points of the embodiments of the present disclosure.

4. By calculating the loss function, a relationship between the policy of the prediction network and the optimization policy is established to iteratively update the parameters of the prediction network, such that the prediction control variable output by the prediction network is gradually approximate to more anthropomorphic decision-making and the decision-making model has better decision-making ability, which is one of the inventive points of the embodiments of the present disclosure.

5. In a process of training the prediction network, experience data satisfying preset conditions is selected from the experience pool at a preset frequency and added to the training sample set of the target network and the parameters of the target network are updated, such that the decision-making model has better planning efficiency, which is one of the inventive points of the embodiments of the present disclosure.

### BRIEF DESCRIPTION OF THE DRAWINGS

In order to more clearly describe the embodiments of the present disclosure or the technical solutions in the prior arts, brief descriptions will be made below to the accompanying drawings involved in the descriptions of the embodiments or the prior arts. Apparently, the accompanying drawings in the following descriptions are merely some embodiments of the present disclosure and other drawings may be obtained by those skilled in the art based on these drawings without making creative work.

FIG. 1 is a flowchart illustrating a method of generating a lane changing decision-making model according to an embodiment of the present disclosure.

FIG. 2 is a flowchart illustrating a process of training a lane changing decision-making model according to an embodiment of the present disclosure.

FIG. 3 is a principle schematic diagram illustrating a process of training a lane changing decision-making model according to an embodiment of the present disclosure.

FIG. 4 is a flowchart illustrating a method of lane changing decision-making of an unmanned vehicle according to an embodiment of the present disclosure.

FIG. 5 is a principle schematic diagram illustrating a method of lane changing decision-making of an unmanned vehicle according to an embodiment of the present disclosure.

FIG. 6 is a structural schematic diagram illustrating an apparatus for generating a lane changing decision-making model according to an embodiment of the present disclosure.

FIG. 7 is a structural schematic diagram illustrating a module for training a lane changing decision-making model according to an embodiment of the present disclosure.

FIG. 8 is a structural schematic diagram illustrating an apparatus for lane changing decision-making of an unmanned vehicle according to an embodiment of the present disclosure.

### DETAILED DESCRIPTION OF THE EMBODIMENTS

The technical solutions of the embodiments of the present disclosure will be described fully and clearly below in combination with the accompanying drawings in the embodiments of the present disclosure. Obviously, the described embodiments are merely some embodiments of the present disclosure rather than all embodiments. Other embodiments obtained by those skilled in the art based on these embodiments of the present disclosure without making creative work shall all fall within the scope of protection of the present disclosure.

It is noted that terms “including” and “having” and variations thereof in the embodiments and accompanying drawings of the present disclosure are intended to cover non-exclusive inclusion. For example, processes, methods, systems, products or devices including a series of steps or units are not limited to the listed steps or units but optionally further include unlisted steps or units or optionally further include other steps or units inherent to these processes, methods, products, or devices.

The embodiments of the present disclosure provide a method for generating a lane changing decision-making model and a method and an apparatus for lane changing decision-making of an unmanned vehicle, which will be detailed below one by one in the following embodiments.

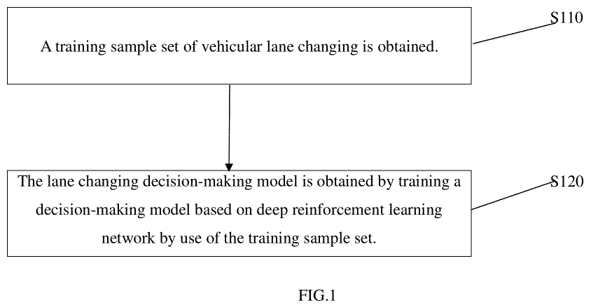

FIG. 1 is a flowchart illustrating a method of generating a lane changing decision-making model according to an embodiment of the present disclosure. The method specifically includes the following steps.

At step S110, a training sample set of vehicular lane changing is obtained, where the training sample set includes a plurality of training sample groups, each of the training sample groups includes a training sample under each time step length in a process that the vehicle completes lane changing based on a planned lane changing trajectory, the training sample includes a group of state variables and corresponding control variables, the state variables include a pose, a speed and an acceleration of a target vehicle, a pose, a speed and an acceleration of a front vehicle in the present lane of the target vehicle and a pose, a speed and an acceleration of a following vehicle in a target lane; and the control variables include a speed and an angular speed of the target vehicle.

During a lane changing of the unmanned vehicle, a decision-making system needs to perceive external environment based on information input by a sensing system and obtain a next action of the unmanned vehicle based on an input state. A deep neural network based on reinforcement learning needs to learn a relationship between a state variable and a control variable so as to obtain a corresponding training sample set, such that the deep neural network can obtain a corresponding control variable based on the state variable. The training sample set can be obtained in at least one of the following manners:

In a first manner,

a vehicle is enabled to complete lane changing according to a rule-based optimization algorithm in a simulator to obtain the state variables of the target vehicle, the front vehicle in the present lane of the target vehicle and the following vehicle in the target lane under each time step length during a process of multiple lane changings and the corresponding control variables.

In the first manner, based on the rule-based optimization algorithm, a simulation vehicle achieves multiple smooth lane changings based on the optimization algorithm in the simulator to obtain the state variable under each time step length in the lane changing process and the corresponding control variable, such that the neural network can learn a correspondence between the state variable and the corresponding control variable, where the optimization algorithm may be mixed integer quadratic programming (MIQP) algorithm.

In a second manner,

vehicle data in a vehicular lane changing is sampled from a database storing vehicular lane changing information, where the vehicle data includes the state variables of the target vehicle, the front vehicle in the present lane of the target vehicle and the following vehicle in the target lane under each time step length and the corresponding control variables.

In the second manner, data desired by the training sample set is obtained from the database such that the deep neural network can have an ability of a given degree of anthropomorphic decision-making after being trained based on the training sample set.

At step S120, the lane changing decision-making model is obtained by training a decision-making model based on deep reinforcement learning network by use of the training sample set, where the lane changing decision-making model enables the state variable of the target vehicle and the corresponding control variable to be correlated.

In an embodiment, the decision-making model based on deep reinforcement learning network includes a learning-based prediction network and a pre-trained rule-based target network.

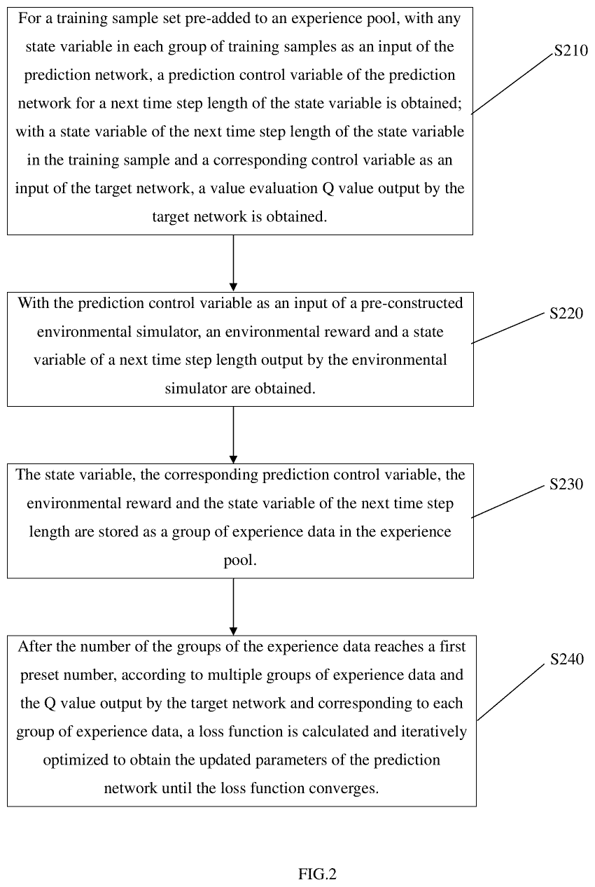

FIG. 2 is a flowchart illustrating a process of training a lane changing decision-making model according to an embodiment of the present disclosure. The training of the lane changing decision-making model specifically include the following steps.

At step S210, for a training sample set pre-added to an experience pool, with any state variable in each group of training samples as an input of the prediction network, a prediction control variable of the prediction network for a next time step length of the state variable is obtained; with a state variable of the next time step length of the state variable in the training sample and a corresponding control variable as an input of the target network, a value evaluation Q value output by the target network is obtained.

The prediction network can predict a control variable to be adopted by the unmanned vehicle at a next time step length according to the state variable under a current time step length whereas the target network obtains a corresponding value evaluation Q value based on the input state variable and the corresponding control variable, where the value evaluation Q value is used to represent goodness and badness of a policy corresponding to the state variable and the control variable.

Therefore, the state variable under the current time step length in the training sample set is input into the prediction network to obtain a prediction control variable of a next time step length output by the prediction network, and a state variable of a next time step length of the state variable in the training sample and a corresponding control variable are input into the target network to obtain a value evaluation of a corresponding policy, thereby obtaining a difference of the control variables obtained based on different policies under the next time step length through comparison.

At step S220, with the prediction control variable as an input of a pre-constructed environmental simulator, an environmental reward and a state variable of a next time step length output by the environmental simulator are obtained.

In order to calculate the value evaluation Q value of the prediction control variable output by the prediction network, the prediction control variable is to be executed and an environmental reward fed back from the environment is obtained. By use of the pre-constructed environmental simulator, simulation execution for the prediction control variable can be achieved so as to obtain an execution result and an environmental reward of the prediction control variable. Thus, the prediction control variable can be evaluated and a loss function is constructed to update the prediction network.

At step S230, the state variable, the corresponding prediction control variable, the environmental reward and the state variable of the next time step length are stored as a group of experience data in the experience pool.

The prediction control variable, the corresponding environmental reward and the state variable of the next time step length are stored in the experience pool. Firstly, more available data of vehicular lane changing is obtained, and secondly, it is helpful to updating the parameters of the target network based on the experience data so as to obtain a more reasonable value evaluation for a control policy, thereby enabling the trained decision-making model to make a more anthropomorphic decision.

At step S240, after the number of the groups of the experience data reaches a first preset number, according to multiple groups of experience data and the Q value output by the target network and corresponding to each group of experience data, a loss function is calculated and optimized to obtain a gradient of change of parameters of the prediction network and the parameters of the prediction network are updated until the loss function converges.

A Q value of value evaluation representing the prediction control variable is calculated according to the environmental reward obtained based on the prediction control variable. According to a plurality of value evaluation Q values of the prediction control variable and the value evaluation Q value corresponding to a training sample under the corresponding time step length, a loss function is constructed which represents a difference between a policy learned by the prediction network currently and a target policy in the training sample. The loss function is optimized based on stochastic gradient descent to obtain a gradient of change of parameters of the prediction network and thus the parameters of the prediction network are updated continuously until the loss function converges. In this way, the difference between the policy of the prediction network and the target policy is reduced such that the decision-making model can output a more reasonable and more anthropomorphic decision control variable.

In a specific embodiment, after the step of, after the number of the groups of the experience data reaches the first preset number, according to the experience data, calculating and iteratively optimizing the loss function and obtaining the updated parameters of the prediction network, is performed, the method further includes: after the number of the updates of the parameters of the prediction network reaches a second preset number, obtaining a prediction control variable with an environmental reward higher than a preset value and a corresponding state variable in the experience pool, or obtaining prediction control variables with environmental rewards ranked in top third preset number and corresponding state variables in the experience pool, and adding the prediction control variable and the corresponding state variable to a target network training sample set of the target network to train and update the parameters of the target network.

By updating the parameters of the target network, the decision-making model can be optimized online such that the decision-making model has a better planning efficiency and obtains more stable effect.

In a specific embodiment, the loss function is a mean square error of a first preset number of value evaluation Q values of the prediction network and the value evaluation Q value of the target network, wherein the value evaluation Q value of the prediction network is about an input state variable, a corresponding prediction control variable and a policy parameter of the prediction network; and the value evaluation Q value of the target network is about a state variable of an input training sample, a corresponding control variable and a policy parameter of the target network.

In this embodiment, in the training method, a loss function is constructed to optimize the parameters of the prediction network such that the prediction network finds a better policy for solving the complex problem of a vehicular lane changing, and the learning-based neural network is directed according to a rule-based policy to perform spatial search from state variable to control variable so as to put the planning-based optimization algorithm into a frame of the reinforcement learning, thereby improving the planning efficiency of the prediction network and increasing the stability of the model.

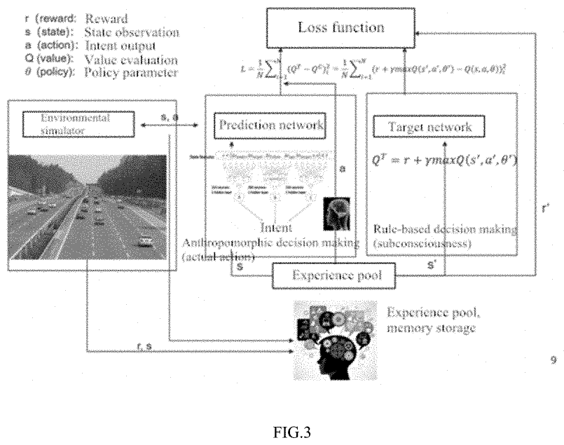

FIG. 3 is a principle schematic diagram illustrating a process of training a lane changing decision-making model according to an embodiment of the present disclosure. As shown in FIG. 3, for a training sample set pre-added to an experience pool, with any state variable s in each group of training samples as an input of the prediction network, a prediction control variable a of the prediction network for a next time step length of the state variable is obtained; with a state variable s′ of the next time step length of the state variable in the training sample and a corresponding control variable a′ as an input of the target network, a value evaluation Q^{T} value output by the target network is obtained; with the prediction control variable a as an input of a pre-constructed environmental simulator, an environmental reward r and a state variable s1 of the next time step length output by the environmental simulator are obtained; the state variable s, the corresponding prediction control variable a, the environmental reward r and the state variable s1 of the next time step length are stored as a group of experience data into the experience pool; after the number of the groups of the experience data reaches the first preset number, according to multiple groups of experience data and the Q^{T} value output by the target network and corresponding to each group of experience data, a loss function is calculated and iteratively optimized to obtain the updated parameters of the prediction network until the loss function converges.

In this embodiment, according to the policy optimization that, in the target network, the learning-based neural network is directed according to the rule-based policy, the planning-based optimization algorithm is put into the frame of the reinforcement learning. In this way, the advantage that the neural network can directly receive the sensor data input is maintained, and the planning efficiency of the prediction network is improved, and further, the addition of the planning-based policy increases the stability of the model.

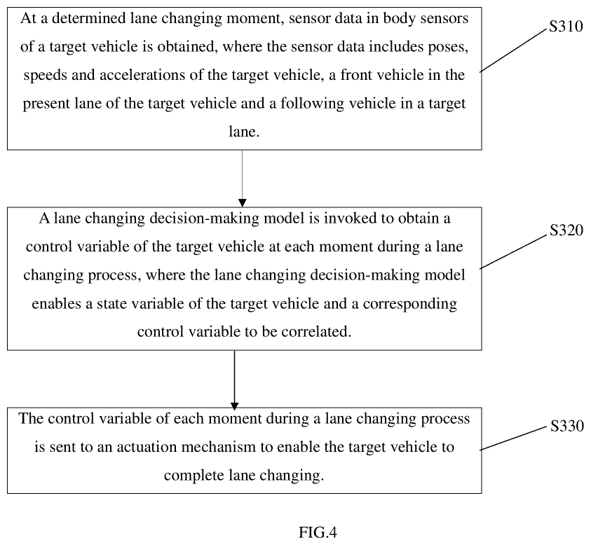

FIG. 4 is a flowchart illustrating a method of lane changing decision-making of an unmanned vehicle according to an embodiment of the present disclosure. The method includes the following steps.

At step S310, at a determined lane changing moment, sensor data in body sensors of a target vehicle is obtained, where the sensor data includes poses, speeds and accelerations of the target vehicle, a front vehicle in the present lane of the target vehicle and a following vehicle in a target lane.

The poses, the speeds and the accelerations of the target vehicle, the front vehicle in the present lane of the target vehicle and the following vehicle in the target lane are obtained and a control variable to be executed by the target vehicle to achieve lane changing is obtained based on these data.

At step S320, a lane changing decision-making model is invoked to obtain a control variable of the target vehicle at each moment during a lane changing process, where the lane changing decision-making model enables a state variable of the target vehicle and a corresponding control variable to be correlated.

At step S330, the control variable of each moment during a lane changing process is sent to an actuation mechanism to enable the target vehicle to complete lane changing.

From an initial moment of lane changing, a corresponding control variable is obtained by calculating the state variable of the target vehicle under each time step length by using the lane changing decision-making model, such that the target vehicle can achieve smooth lane changing based on the corresponding control variable.

In this embodiment, the sensor data in the body sensors of the target vehicle is directly input into the lane changing decision-making model trained by the method of generating a lane changing decision-making model, such that the decision-making model can output a corresponding control variable at the corresponding moment. In this way, the target vehicle can achieve smooth lane changing. Therefore, the decision-making model can directly receive the input of the sensors and have better planning efficiency.

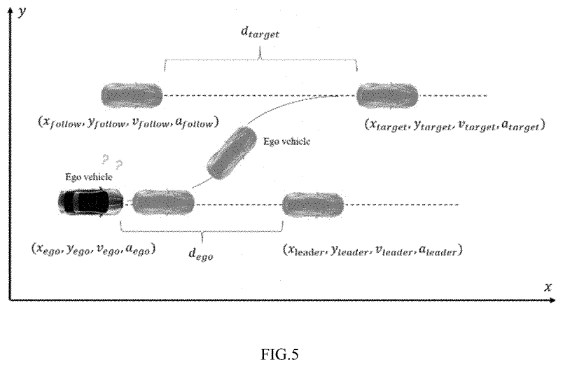

FIG. 5 is a principle schematic diagram illustrating a method of lane changing decision-making of an unmanned vehicle according to an embodiment of the present disclosure. As shown in FIG. 5, at a determined lane changing moment, sensor data in body sensors of a target vehicle is obtained, where the sensor data includes a pose, a speed and an acceleration of the target vehicle, a pose, a speed and an acceleration of the front vehicle in the present lane of the target vehicle and a pose, a speed and an acceleration of the following vehicle in the target lane; a lane changing decision-making model is invoked to obtain a control variable of the target vehicle at each moment during a lane changing process; the control variable of each moment is executed o enable the target vehicle to complete lane changing.

In this embodiment, the lane changing decision-making model trained by the method of generating a lane changing decision-making model can directly receive sensor data input from the body sensors of the target vehicle and output a corresponding control variable at the corresponding moment, such that the target vehicle can achieve smooth lane changing. In the lane changing decision-making method, with the sensor data as direct input of the decision-making model, the unmanned vehicle can achieve smooth lane changing based on the anthropomorphic decision.

Corresponding to the method of generating a lane changing decision-making model and a method of lane changing decision-making of an unmanned vehicle as mentioned above, the present disclosure further provides embodiments of an apparatus for generating a lane changing decision-making model and an apparatus for lane changing decision-making of an unmanned vehicle. The apparatus embodiments can be implemented by software or by hardware or by combination thereof. With implementation with software as an example, the apparatus as a logical apparatus is formed by reading corresponding computer program instructions in a non-volatile memory into an internal memory for running by use of a processor of a device where the apparatus is located. From the hardware level, a hardware structure of a device where the apparatus for generating a lane changing decision-making model and the apparatus for lane changing decision-making of an unmanned vehicle are located in the present disclosure may include a processor, a network interface, an internal memory and a non-volatile memory and may also include other hardware, which will not be repeated herein.

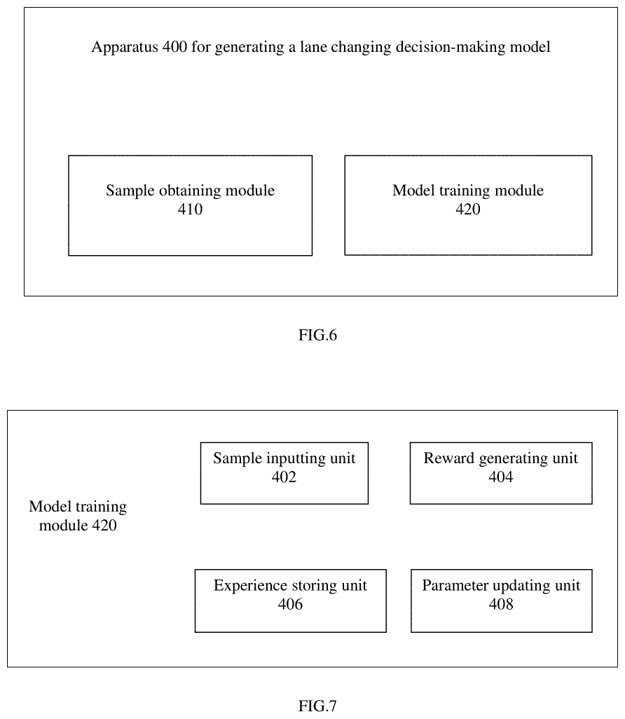

FIG. 6 is a structural schematic diagram illustrating an apparatus 400 for generating a lane changing decision-making model according to an embodiment of the present disclosure. The apparatus 400 may include:

a sample obtaining module 410, configured to obtain a training sample set of vehicular lane changing, where the training sample set includes a plurality of training sample groups, each of the training sample groups includes a training sample under each time step length in a process that the vehicle completes lane changing based on a planned lane changing trajectory, the training sample includes a group of state variables and corresponding control variables, the state variables include a pose, a speed and an acceleration of a target vehicle, a pose, a speed and an acceleration of a front vehicle in the present lane of the target vehicle and a pose, a speed and an acceleration of a following vehicle in a target lane; and the control variables include a speed and an angular speed of the target vehicle;

a model training module 420, configured to obtain the lane changing decision-making model by training a decision-making model based on deep reinforcement learning network by use of the training sample set, where the lane changing decision-making model enables the state variable of the target vehicle and the corresponding control variable to be correlated.

In a specific embodiment, the sample obtaining module 410 obtains the training sample set in at least one of the following manners:

In a first manner,

a vehicle is enabled to complete lane changing according to a rule-based optimization algorithm in a simulator to obtain the state variables of the target vehicle, the front vehicle in the present lane of the target vehicle and the following vehicle in the target lane under each time step length during a process of multiple lane changings and the corresponding control variables;

In a second manner

vehicle data in a vehicular lane changing is sampled from a database storing vehicular lane changing information, where the vehicle data includes the state variables of the target vehicle, the front vehicle in the present lane of the target vehicle and the following vehicle in the target lane under each time step length and the corresponding control variables.

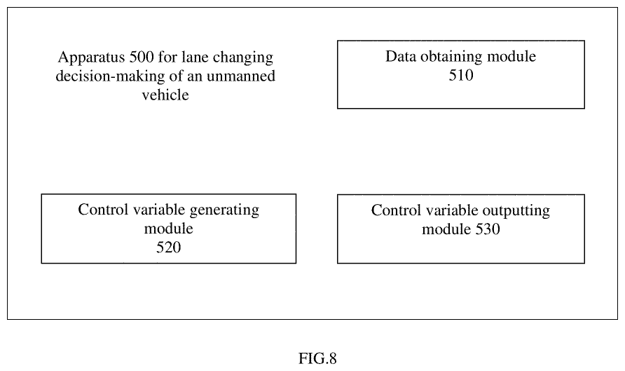

FIG. 7 is a structural schematic diagram illustrating a module for training a lane changing decision-making model according to an embodiment of the present disclosure. The decision-making model based on deep reinforcement learning network includes a learning-based prediction network and a pre-trained rule-based target network. The model training module 420 includes:

a sample inputting unit 402, configured to, for a training sample set pre-added to an experience pool, with any state variable in each group of training samples as an input of the prediction network, obtain a prediction control variable of the prediction network for a next time step length of the state variable; with a state variable of the next time step length of the state variable in the training sample and a corresponding control variable as an input of the target network, obtain a value evaluation Q value output by the target network;

a reward generating unit 404, configured to, with the prediction control variable as an input of a pre-constructed environmental simulator, obtain an environmental reward and the state variable of the next time step length output by the environmental simulator;

an experience storing unit 406, configured to store the state variable, the corresponding prediction control variable, the environmental reward and the state variable of the next time step length as a group of experience data into the experience pool;

a parameter updating unit 408, configured to, after the number of the groups of the experience data reaches a first preset number, according to multiple groups of experience data and the Q value output by the target network and corresponding to each group of experience data, calculate and optimize a loss function to obtain a gradient of change of parameters of the prediction network and update the parameters of the prediction network until the loss function converges.

In a specific embodiment, the parameter updating unit 408 is further configured to:

after the number of the updates of the parameters of the prediction network reaches a second preset number, obtain a prediction control variable with an environmental reward higher than a preset value and a corresponding state variable in the experience pool, or obtain prediction control variables with environmental rewards ranked in top third preset number and corresponding state variables in the experience pool, and add the prediction control variable and the corresponding state variable to a target network training sample set of the target network to train and update the parameters of the target network.

In a specific embodiment, the loss function is a mean square error of a first preset number of value evaluation Q values of the prediction network and the value evaluation Q value of the target network, where the value evaluation Q value of the prediction network is about an input state variable, a corresponding prediction control variable and a parameter of the prediction network; and the value evaluation Q value of the target network is about a state variable of an input training sample, a corresponding control variable and a parameter of the target network.

FIG. 8 is a structural schematic diagram illustrating an apparatus 500 for lane changing decision-making of an unmanned vehicle according to an embodiment of the present disclosure. The apparatus 500 specifically includes the following modules:

a data obtaining module 510, configured to, at a determined lane changing moment, obtain sensor data in body sensors of a target vehicle, where the sensor data includes poses, speeds and accelerations of the target vehicle, a front vehicle in the present lane of the target vehicle and a following vehicle in a target lane;

a control variable generating module 520, configured to invoke a lane changing decision-making model to obtain a control variable of the target vehicle at each moment during a lane changing process, where the lane changing decision-making model enables a state variable of the target vehicle and a corresponding control variable to be correlated;

a control variable outputting module 530, configured to send the control variable of each moment during a lane changing process to an actuation mechanism to enable the target vehicle to complete lane changing.

The implementation process of the function and effect of each unit in the above apparatus can be referred to the implementation process of corresponding steps of the above method and will not be repeated herein.

In summary, a decision-making model based on deep reinforcement learning network is trained using an obtained training sample set, and a loss function is constructed to optimize parameter of a prediction network such that the prediction network finds a better policy for solving the complex problem of vehicular lane changing and the policy of the prediction network is continuously approximate to the policy of the training sample data. The decision-making model can correlate the state variable of the target vehicle with the corresponding control variable. Thus, compared with the conventional offline optimization algorithm, the inputs of the sensors can be directly received and good online planning efficiency can be produced, thus solving the problem of difficult decision-making resulting from complex sensors and environmental uncertainty in the prior arts; compared with pure deep neural network, better learning efficiency can be generated and adaptability to specific application scenarios can be increased.

Those skilled in the art may understand that the accompanying drawings are merely schematic diagrams of one embodiment, and modules or flows in the drawings are not necessarily required for implementation of the present disclosure.

Those skilled in the art may understand that the modules in the apparatus of the embodiments may be distributed in the apparatus of the embodiments based on the descriptions of the embodiments or changed accordingly to be distributed in one or more apparatuses of different embodiments. The modules in the above embodiments may be combined into one module or may be further split into a plurality of sub-modules.

Finally, it should be noted that, the above embodiments are used only to describe the technical solutions of the present disclosure rather than limit the present disclosure. Although the present disclosure is detailed by referring to the above embodiments, those skilled in the art should understand that modification may be performed to the technical solutions recorded in the preceding embodiments or equivalent substitutions are performed for some of the technical features thereof; these modification or substitutions do not cause the essences of corresponding technical solutions to depart from the spirit and scope of the technical solutions of the present disclosure.

1. A method of generating a lane changing decision-making model, comprising:
obtaining a training sample set of vehicular lane changing, wherein the training sample set comprises a plurality of training sample groups, each of the training sample groups comprises a training sample under each time step length in a process that the vehicle completes lane changing based on a planned lane changing trajectory, the training sample comprises a group of state variables and corresponding control variables; and
obtaining the lane changing decision-making model by training a decision-making model based on deep reinforcement learning network by use of the training sample set, wherein the lane changing decision-making model enables the state variables of the target vehicle and the corresponding control variables to be correlated.

2. The method of claim 1, wherein the training sample set is obtained in the following manner:
a vehicle is enabled to complete lane changing according to a rule-based optimization algorithm in a simulator to obtain the state variables of the target vehicle, the front vehicle in the present lane of the target vehicle and the following vehicle in the target lane under each time step length during a process of multiple lane changings and the corresponding control variables.

3. The method of claim 1, wherein the decision-making model based on deep reinforcement learning network comprises a learning-based prediction network and a pre-trained rule-based target network.

4.-5. (canceled)

6. A method of lane changing decision-making of an unmanned vehicle, comprising:
at a determined lane changing moment, obtaining sensor data in body sensors of a target vehicle;
invoking a lane changing decision-making model generated by the method according to claim 1 to obtain a control variable of the target vehicle at each moment during a lane changing process, wherein the lane changing decision-making model enables a state variable of the target vehicle and a corresponding control variable to be correlated; and
sending the control variable of each moment during a lane changing process to an actuation mechanism to enable the target vehicle to complete lane changing.

7.-10. (canceled)

11. The method of claim 1, wherein the state variables comprise a pose, a speed and an acceleration of a target vehicle, a pose, a speed and an acceleration of a front vehicle in the present lane of the target vehicle and a pose, a speed and an acceleration of a following vehicle in a target lane; and the control variables comprise a speed and an angular speed of the target vehicle.

12. The method of claim 1, wherein the training sample set is obtained in the following manner:
vehicle data in a vehicular lane changing is sampled from a database storing vehicular lane changing information, wherein the vehicle data comprises the state variables of the target vehicle, the front vehicle in the present lane of the target vehicle and the following vehicle in the target lane under each time step length and the corresponding control variables.

13. The method of claim 1, wherein the step of obtaining the lane changing decision-making model by training the decision-making model based on deep reinforcement learning network by use of the training sample set comprises:
for a training sample set pre-added to an experience pool, with any state variable in each group of training samples as an input of the prediction network, obtaining a prediction control variable of the prediction network for a next time step length of the state variable; with a state variable of the next time step length of the state variable in the training sample and a corresponding control variable as an input of the target network, obtaining a value evaluation Q value output by the target network;
with the prediction control variable as an input of a pre-constructed environmental simulator, obtaining an environmental reward and a state variable of the next time step length output by the environmental simulator;
storing the state variable, the corresponding prediction control variable, the environmental reward and the state variable of the next time step length as a group of experience data into the experience pool; and
according to multiple groups of experience data and the Q value output by the target network and corresponding to each group of experience data, calculating and optimizing a loss function to obtain a gradient of change of parameters of the prediction network and updating the parameters of the prediction network until the loss function converges.

14. The method of claim 13, wherein after the number of the groups of the experience data reaches a first preset number, according to multiple groups of experience data and the Q value output by the target network and corresponding to each group of experience data, calculating and optimizing a loss function to obtain a gradient of change of parameters of the prediction network and updating the parameters of the prediction network until the loss function converges.

15. The method of claim 14, wherein after the number of the groups of the experience data reaches the first preset number, according to the experience data, calculating and optimizing the loss function to obtain the gradient of change of the parameters of the prediction network and updating the parameters of the prediction network until the loss function converges, is performed, the method further comprises:
after the number of the updates of the parameters of the prediction network reaches a second preset number, obtaining a prediction control variable with an environmental reward higher than a preset value and a corresponding state variable in the experience pool, or obtaining prediction control variables with environmental rewards ranked in top third preset number and corresponding state variables in the experience pool, and adding the prediction control variables and the corresponding state variables to a target network training sample set of the target network to train and update the parameters of the target network.

16. The method of claim 14, wherein the loss function is a mean square error of a first preset number of value evaluation Q values of the prediction network and the value evaluation Q value of the target network, wherein the value evaluation Q value of the prediction network is about an input state variable, a corresponding prediction control variable and a policy parameter of the prediction network; and the value evaluation Q value of the target network is about a state variable of an input training sample, a corresponding control variable and a policy parameter of the target network.

17. The method according to claim 6, wherein the sensor data comprises poses, speeds and accelerations of the target vehicle, a front vehicle in the present lane of the target vehicle and a following vehicle in a target lane.

18. An electronic device comprising one or more processors and a memory, wherein the memory is configured to store program instructions; and the one or more processors are configured to execute the program instructions stored in the memory, and when the one or more processors execute the program instructions stored in the memory, the electronic device is configured to perform the method of lane changing decision-making of an unmanned vehicle according to claim 6.
